(19) United States
(12) Patent Application Publication
(10) Pub. No.: US 2003/0089441 A1
(43) Pub. Date: May 15, 2003

(54) Bracing ply comprising reinforcing elements for a vehicle pneumatic tire, and vehicle pneumatic tire

(76) Inventors: Stefan Fischer, Hannover (DE); Wolfgang Elanor, Garbeen (DE); Hans-Mardin Billing, Hannover (DE); Peter Klaus, Pattensen (DE)

Correspondence Address: Robert W Becker & Associates, Suite B, 707 Highway 66 East, Tijeras, NM, 87059, US

(21) Appl. No.: 10/240,621

(22) PCT Filed: Mar. 22, 2001
(86) PCT No.: PCT/EP01/03296

(30) Foreign Application Priority Data
Mar. 31, 2000 (DE) 100 16 202.9

(51) Int. Cl. B60C 9/20; B60C 9/18; B60C 9/00; D07B 1/06; B32B 25/00

(52) U.S. Cl. 152/527; 152/526; 152/451; 428/295.4

(57) ABSTRACT

The invention relates to a bracing ply comprising reinforcing elements, which are made of steel cords, for a vehicle pneumatic tire, in particular, for a pneumatic tire used on transporters or light trucks and reinforced pneumatic tires. Said bracing ply is provided with two steel cord plies (bracing plies) which are stacked in a radial direction, whereby the radially inner steel cord ply is wider in the axial direction of the tire than the radially outer steel cord ply. In addition, the individual steel cords of a ply run diagonally with a slope ranging from 18° to 25° with regard to the zenithal plane of the tire. The radially inner and the radially outer steel cord plies have opposed slopes, are comprised of individual filaments with a filament diameter of 0.32 mm, and are provided with a U+T structure (untwisted+twisted), whereby the radial distance between steel cord plies is smaller in the zenithal plane of the tire than in the shoulder areas.

The invention relates to a belt, comprised of reinforcing elements having steel cords, for a pneumatic vehicle tire, in particular, a belt for a pneumatic tire used on transporters or light trucks, and strengthened (Reinforced) pneumatic tires, whereby the pneumatic vehicle tires are substantially comprised of a tread strip having a tread profile, two sidewalls, a carcass provided with carcass plies and, optionally, reinforcing elements, a belt comprised of belt plies and, optionally, one or several belt bands and further inserts, as well as two tire beads provided with bead cores, whereby the belt is comprised of elastomeric material reinforced with two steel cord plies (belt plies) arranged one over the other in the radial direction, whereby the individual steel cords of a ply are arranged parallel to one another and parallel to the zenith plane of the tire—that is, inclined relative to the circumferential direction of the tire—and whereby the steel cords of the radially inner and the radially outer steel cord ply have opposite inclinations, and whereby the steel cords are configured of two groups of filaments in a “U+T” configuration (Untwisted+Twisted) whose first group comprises two untwisted and parallel filaments and whose second group comprises two twisted filaments, whereby the first and the second groups are twisted around one another (braided).

The invention relates as well to a pneumatic vehicle tire for transporters or light trucks or a strengthened (Reinforced) pneumatic vehicle tire for passenger vehicles, which is provided with a belt construction of this type.

Pneumatic vehicle tires for light trucks or transporters, which are typically and internationally designated as “commercial tires” (C-Tire), as well as pneumatic vehicle tires for multi-purpose vehicles, for vans, and for cars having high service load capacity, such as, for example, combination vehicles, which tires typically are designated as “Reinforced Tires”(R), are regularly subjected to high loading and are specially constructed in accommodation thereof.

An accommodation to a high load carrying capacity is effected with both the “commercial tires” as well as the “reinforced tires” by construction measures which achieve either a reinforcement of the carcass, the bead area, or the belt package. In this connection, for example, carcass plies of high strength or several carcass plies of normal strength can be deployed. To the same end, bead reinforcing in the bead area—that is, reinforcement material in the form of woven webs or elastomeric intermediate plies—are provided. In the same manner, the belt package can be subjected to the high loading by configuring the belt package via a special configuration of the belt plies which are universally comprised of cord plies formed of steel cords within elastomeric belt material, via variation of the cord spacing, and via different cord materials such as, for example, those having higher strength. In this regard, the configuration of the belt package has, of course, the greatest influence on configuring the respective tire with respect to high load carrying capacity.

Tires of such construction are, for example, classified in the “ETRTO—Standards—Manual” (European Tire and Rim Technical Organization) into various loading categories (load ranges), approximately in the load ranges B, C, D, and E, which are therein correlated with the previously applied strength classes designated as “Ply Ratings” (PR). These designations typically heretofore resulted from the fact that an increase in the strength with the previously used textile web plies deployed at that time was possible only by an application of such multiple units of such plies.

As a result of the foregoing, the present day “load range B” corresponds approximately to the earlier classification 4PR, the “load range C” corresponds approximately to 6PR, the “load range D” corresponds approximately to 8PR, and the “load range E” corresponds approximately to 10PR. The PR count determines, typically, the respective required specified air pressure.

Via these classification categories, a load index (LI) can be given which is substantially dependent upon the tire size and dimension—that is, a load carrying capacity characterization can be given which can, additionally, characterize the normal maximum allowable loading in kilograms per individual tire.

The tensile strength of the steel cords in the belt naturally have a great influence on the load carrying capacity and, thus, the specified assignment of the tire into the classifications into the load classes, whereby the steel cords are typically classified into those with a high tension capability—namely, “high tensile” (HT) cords, those with normal tension capability “normal tension” (NT) and also, as the occasion arises, those with especially high tensile strength “super tensile” (ST). In this manner, the “HT-cords” exhibit, for example, a minimum tensile strength of 850 N and the “NT-cords” exhibit a minimum tensile strength of 745 N.

Thus, U.S. Pat. No. 5,242,001 discloses a radial pneumatic tire in the load classification E (Load range E) with a belt having substantially the same width as the tread width, which comprises two plies of steel cords integrated into the elastomeric material of the belt, whereby the cords are configured, as well, in a “U+T” construction. In this radial pneumatic tire, however, the relatively expensive “ST cords” are deployed and, in this manner, the accommodation of the tire to the high loading classification is principally effected via a material exchange.

The making available of such pneumatic tires—mainly, the “commercial tires” and the “reinforced tires” in accordance with the above-noted load categories—is, however, burdened with several disadvantages in the production and in the handling thereof which cannot be overlooked. On the one hand, the finish preparation of the tire through the additional deployment of reinforcement material and through additional finishing steps influences the cost viability of such tires and, on the other hand, such measures produce a correspondingly higher cost of the tire due to the associated higher weight and, as well, a higher rolling resistance results, so that, ultimately, the energy usage cost of a vehicle outfitted with such tires rises as well. The exclusive deployment of lighter cords with lower strength can also not solve the weight problem, as, for example, either the number of cords or, on the other hand, the diameter—that is, the volume of the cords—in relation to the encircling elastomeric material, must be increased. This increase of, for example, the cord diameter, however, runs against geometric limits in connection with the use of several cord plies and brings with it problems in view of the required deployment of elastomeric material or, respectively, rubber, between the cords and the individual filaments.

For the invention, therefore, the challenge was raised to provide a belt construction or, respectively, a pneumatic vehicle tire, with a belt construction, which exhibits a reduced weight with a high belt strength, which permits an increased cost viability in connection with the manufacture thereof and which permits a simplified construction, whose mass is held to the minimum value possible and, in the region of the belt rubber application, is produced with the least possible material and can be deployed without a downgrading or reduction thereof with respect to its classification into the designated load classification.

This challenge is met by the features of the principal claim. Further advantageous embodiments are set forth in the dependent claims. Likewise, this challenge is met by the features of claim 8, whereby, as well, advantageous embodiments are set forth in the features of the claims dependent therefrom.

In connection with the invention, the radial inner steel cord ply of the belt is configured with a greater width in the axial direction of the tire than the radial outer steel cord ply. The individual steel cords of a ply are parallel to one another and extend at an inclination of 18° to 25° relative to the zenith plane of the tire, whereby the steel cords of the radially inner and the radially outer steel cord ply have an opposite inclination and are comprised of individual filaments having a filament diameter of 0.32 mm. The steel cords are accordingly configured of two groups of filaments in a “U+T” (Untwisted+Twisted) configuration whose first group comprises two untwisted and parallel filaments, preferably two filaments with a large twist length SL of ≧100 mm and whose second group comprises two twisted filaments with a twist length SL of 12 to 18 mm, preferably, 16 mm, for disposing the respective cords around one another (braided), and whereby the radial spacing of the steel cord plies in the zenith plane of the tire is less than in its shoulder area.

The type of twisting of the filaments with one another as well as the twisting of the cord groups with one another can be configured as both an “S” twist or as a “Z” twist, so that therefore, for example, the two filament groups can be twisted with a twist length of 16 millimeters in an “S twist” and the two thus-formed groups can be twisted with one another in a “Z twist”.

The use of such a “U+T” construction in the specified twist lengths leads to an excellent projection or extension of the elastomeric material/the rubber between the cords as well as between the filaments—that is, a projection or extension thereof into the cords—which effects the desired high adhesion between the rubber and the steel cord and prevents the inclusion of air bubbles.

The cord configured in such a manner is typically designated as “2+2×32 U+T”.

In combination with the individual features, a construction of this type leads to a pneumatic vehicle tire having a high load carrying capacity with a weight which is approximately 250-500 g per tire lighter than the conventional pneumatic vehicle tires in comparable load classifications.

In the same manner, there is produced an increased cost viability in connection with the manufacture of such a tire due to the optimally simple and cost favorable “2+2 construction” and, moreover, it is possible to apply a relatively thin rubber application in the belt region due to the small cord diameter of 0.32 millimeters of the deployed filament. In connection with the filament diameter, the concept of a specified diameter, it is, of course, to be understood that the diameter, due to the reason of finishing tolerances, can vary within a tolerance range of +/−5%. Typically, numerous dimension and manufacturing characteristics are dependent upon the condition of the raw material, which, due to further working of the tire to be manufactured—if only within a very limited range—is still subjected to variations.

Of course, a tire construction of this type can be completed with the typical measures such as, for example, with a belt band with reinforcement plies of nylon, polyester, or aramid, which can be built up or spooled onto 1 to 3 plies around the belt package, in accordance with the respective configuration.

In particular in an advantageous configuration, in which the radial distance of the steel cord plies of the belt in the zenith plane of the tires is 0.30-0.85 mm and, in the shoulder regions, is 1.20-2.40 mm, and in which the radial inner steel cord ply of the belt is, in the axial direction of the tire, 10-15 mm wider than the radially outer steel cord ply, one can achieve with the tire that the load acting on the tread surface of the tire is, in a certain respect, shifted in a “staggered” manner into the side regions of the tire and thereby the heat critical shoulder regions, in which it is conventionally known that the first appearances of separation can form, can remain completely non-critical in the specified high load classification.

A further advantage is provided that the individual and parallel to one another belt-steel cords of a ply have a distance of 0.45-1.65 mm to one another and that the number of steel cords per decimeter of a steel cord ply—measured perpendicular to the extension of the cord—is between 40 and 75. Via such a construction, the load carrying capacity of the tire is increased without introducing additional weight in the tire construction.

Advantageously, the tensile strength of the steel cord in the green or uncured material and before the vulcanization of the finished tire is a value of 805 N. The cords used in this connection belong, thus, to the “normal tensile” range and are found principally in the load classification (load range) B.

Another advantageous embodiment has the feature that the tensile strength of the steel cord in the green or uncured material and before the vulcanization of the uncured tire to form a cured tire is 910 N, whereby the load classes (Load Ranges) C and D can be provided for in a problem-free manner.

Thus, a “Load Range C” pneumatic tire of the invention having the tire size 205/65 R15 C comprises steel cord with a tensile strength of 910 N (High Tensile). In this tire, the radial spacing of the steel cord plies in the zenith plane is 0.5 mm and 2 mm in the shoulder region. The individual steel cords of a ply, which extend parallel to one another, have, in this configuration, a spacing of 1.0 mm. In connection with the assignment to such a tire of the specified air pressure of 3.5-3.75 bar corresponding to the load class PR 6 (Ply Rating), the load index (LI) characterizing the load character of the tire is 102/100, which yields a maximum loading of 850 kg per tire in connection with single tire mountings and 800 kg per tire in connection with tandem tire mountings.

As a further example for a “Load Range D” tire of the invention with HT cords—that is, cords with a tensile strength of 910 N, the tire size 185 R14 C can be produced, in which likewise the radial spacing of the steel cord plies in the zenith plane is 0.5 mm and 2 mm in the shoulder region and the individual steel cords of a ply, which extend parallel to one another, have, in this configuration, a spacing of 1.0 mm. In connection with the assignment to such tire of a specified air pressure of 4.50-4.75 bar corresponding to the load class PR 8, the load carrying capacity characteristic, expressed via the load index (LI) of 102/100 for tandem tire mountings, also corresponds to a maximum load of 850 or, respectively, 800, kg per tire.

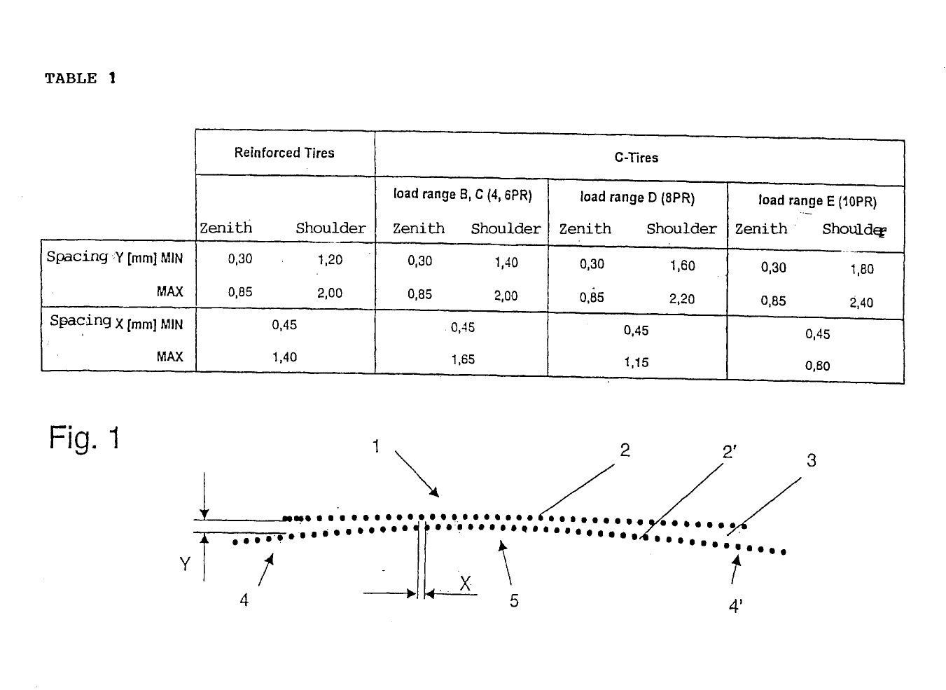

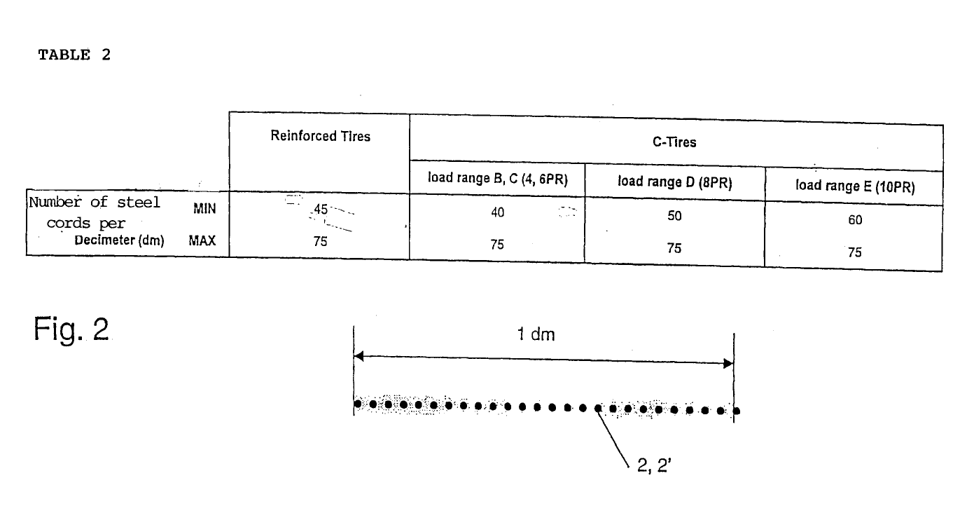

FIGS. 1 and 2 once again show, in addition to the Tables 1 and 2 corresponding therewith, the embodiment of the inventive belt or, respectively, the corresponding pneumatic vehicle tire having such a belt.

In this connection, in Table 1 are shown the different spacings (Y) of the steel cord plies in the zenith plane and in the shoulder regions, as a function of the different load classes (Load Ranges), as well as the spacing (X) of the individual steel cord plies extending parallel to one another in a ply of the belt, likewise as a function of the load classes (Load Ranges).

FIG. 1 makes clear this relationship via a conceptual sketch and shows a belt 1 (a belt package) comprised of steel cord plies 2 and 2′ which are integrated into the elastomeric material 3 of the belt as reinforcement elements. The radially inner steel cord ply 2*, in this connection, is configured significantly wider than the radially outer steel cord ply 2 in the axial direction of the tire—that is, across the tire width. Likewise, it can be seen that the radial spacing of the steel cord plies 2 and 2* in the zenith plane 5 of the tire is less than in the shoulder regions 4 and 4*.

FIG. 2 shows, for the steel cord plies 2 and 2*, the number of steel cords per decimeter measured perpendicular to the extent of the cords and as a function of the load classes (Load Ranges). The illustration depicts the situation for the upper as well as the lower steel cord belt ply. FIG. 2 emphasizes this embodiment once again as a conceptual sketch.

1. A belt comprised of reinforcing elements having steel cords for a pneumatic vehicle tire, in particular, a belt for a pneumatic tire used on transporters or light trucks, and strengthened (Reinforced) pneumatic tires, whereby the pneumatic vehicle tires are substantially comprised of a tread strip having a tread profile, two sidewalls, a carcass provided with carcass plies and, optionally, reinforcing elements, a belt (1) comprised of belt plies and, optionally, one or several belt bands and further inserts, as well as two tire beads provided with bead cores, whereby the belt is comprised of elastomeric material (3) reinforced with two steel cord plies (belt plies 2 and 2*) arranged one over the other in the radial direction, whereby the radially inner steel cord ply (2*) is configured wider in the axial direction of the tire than the radially outer steel cord ply (2), whereby the individual steel cords of a ply are arranged parallel to one another and extend at an inclination of 18° to 25° relative to the zenith plane of the tire, whereby the steel cords of the radially inner and the radially outer steel cord ply have an opposite inclination and are comprised of individual filaments having a filament diameter of 0.32 mm, and whereby the steel cords are formed of two groups of filaments configured in a “U+T” (Untwisted+Twisted) configuration whose first group comprises two untwisted and parallel filaments, preferably two filaments with a large twist length SL of ≧100 mm and having substantially parallel filaments, and whose second group comprises two twisted filaments with a twist length SL of 12 to 18 mm, preferably, 16 mm, whereby the first and second groups of filaments are disposed around one another (braided) with a twist length SL of 12 to 18 mm, preferably 16 mm, and whereby the radial spacing of the steel cord plies in the zenith plane of the tire is less than in the shoulder areas (4,4′).

2. A belt according to claim 1, characterized in that the radial distance of the steel cord plies of the belt in the zenith plane of the tires is 0.30 to 0.85 mm and, in the shoulder regions, is 1.20 to 2.40 mm.

3. A belt according to claim 2, characterized in that the radially inner steel cord ply of the belt is, in the axial direction of the tire, 10 to 15 mm wider than the radially outer steel cord ply.

4. A belt according to claims 1 to 3, characterized in that the individual steel cords of a ply, which extend parallel to one another, have a distance of 0.45 to 1.65 mm to one another.

5. A belt according to claims 1 to 4, characterized in that the number of steel cords per decimeter of a steel cord ply—measured perpendicular to the extension of the cord—is between 40 and 75.

6. A belt according to claims 1 to 5, characterized in that the tensile strength of the steel cord in the green or uncured material and before the vulcanization of the finished tire is a value of 805 N.

7. A belt according to claims 1 to 5, characterized in that the tensile strength of the steel cord in the green or uncured material and before the vulcanization of the finished tire is a value of 910 N.

8. Pneumatic vehicle tires for transporters or light trucks, or strengthened (Reinforced) pneumatic vehicle tires for passenger vehicles, whereby the pneumatic vehicle tires are substantially comprised of a tread strip having a tread profile, two sidewalls, a carcass provided with carcass plies and, optionally, reinforcing elements, a belt (1) comprised of belt plies and, optionally, one or several belt bands and further inserts, as well as two tire beads provided with bead cores, whereby the belt (1) is comprised of elastomeric material (3) reinforced with two steel cord plies (belt plies 2, 2*) arranged one over the other in the radial direction, whereby the radially inner steel cord ply (2*) is configured wider in the axial direction of the tire than the radially outer steel cord ply (2), whereby the individual steel cords of a ply are arranged parallel to one another and extend at an inclination of 18° to 25° relative to the zenith plane of the tire, whereby the steel cords of the radially inner and the radially outer steel cord ply have an opposite inclination and are comprised of individual filaments having a filament diameter of 0.32 mm, and whereby the steel cord of two groups of filaments are configured in a “U+T” (Untwisted+Twisted) configuration whose first group comprises two untwisted and parallel filaments, preferably two filaments with a large twist length SL of ≧100 mm and having substantially parallel filaments, and whose second group comprises two twisted filaments with a twist length SL of 12 to 18 mm, preferably, 16 mm, whereby the first and second groups of filaments are disposed around one another (braided) with a twist length SL of 12 to 18 mm, preferably 16 mm, and whereby the radial spacing of the steel cord plies in the zenith plane (5) of the tire is less than in its shoulder area (4).

9. Pneumatic vehicle tires according to claim 8, characterized in that the radial distance of the steel cord plies of the belt in the zenith plane of the tires is 0.30 to 0.85 mm and, in the shoulder regions, is 1.20 to 2.40 mm.

10. Pneumatic vehicle tires according to claim 9, characterized in that the radial inner steel cord ply of the belt is, in the axial direction of the tire, 10 to 15 mm wider than the radially outer steel cord ply.

11. Pneumatic vehicle tires according to claims 8 to 10, characterized in that the individual steel cords of a ply, which extend parallel to one another, have a distance of 0.45 to 1.65 mm to one another.

12. Pneumatic vehicle tires according to claims 8 to 11, characterized in that the number of steel cords per decimeter of a steel cord ply—measured perpendicular to the extension of the cord—is between 40 and 75.

13. Pneumatic vehicle tires according to claims 8 to 12, characterized in that the tensile strength of the steel cord in the green or uncured material and before the vulcanization of the finished tire is a value of 805 N.

14. Pneumatic vehicle tires according to claims 8 to 13, characterized in that the tensile strength of the steel cord in the green or uncured material and before the vulcanization of the finished tire is a value of 910 N.
